(19) United States
(12) Patent Application Publication
(10) Pub. No.: US 2008/0314803 A1
(43) Pub. Date: Dec. 25, 2008

(54) Asphalt recycling plant

(75) Inventor: William H. Burke, Ocala, FL (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Stephen Counts, LLC, Ocala, FL (US)

(21) Appl. No.: 11/812,552

(22) Filed: Jun. 20, 2007

(51) Int. Cl. B07B 15/00; B07B 13/16

(52) U.S. Cl. 209/241; 209/240

(57) ABSTRACT

An asphalt recycling plant is described that is oriented vertically with an elevator to convey ground-up road material to a top of the plant. The material moves does the plant by force of gravity through a sifter, sorter, crusher and return facility such that the dust and debris of the recycling process is substantially contained within the facility.

### FIELD OF THE DISCLOSURE

This disclosure relates to asphalt processing and in particular to asphalt material recycling.

### INTRODUCTION

According to the Federal Highway Administration, presently about 80% of old asphalt pavement in the United States is recycled. Recycling begins by grinding up old pavement at a road site, trucking it to a recycling processing facility, re-grinding it into smaller-sized material, grading the material according to size and quality, and then re-mixing the material with some fresh cement additives into new hot mix asphalt product.

Hot mix asphalt is made by combining aggregates with virgin asphalt cement, such as bitumen, a synthetic cement, or an equivalent. Before recycling, the recycled pavement product is graded by size of the ground particles, moisture content, asphalt content, and any other features desired. It is then added to the hot mix asphalt mix and replaces some amount (perhaps all) of the aggregates and some amount (perhaps all) of the asphalt cement depending on the asphalt content of the recycled product. Recycled product that is ground finely and has high asphalt content is highly regarded in making hot mix asphalt for new pavement.

After old pavement is milled at the road site, it is trucked to a recycling facility where the milled pavement is ground, sorted, and graded, as described above. Recycling that product is not new. There are, however, now prior art facilities that not only recycle asphalt product, but also grind and separate the processed old pavement into piles according to particle size, prior to its use in the hot mix operation. In Aggregate & Mining Journal (2005) pp. 26-27, a recycled asphalt processing facility is advertised that crushes, sizes, separates and stores recycled asphalt product within one automated, self-contained system. The system is shown as a relatively geographically-extended facility.

Because of that extended layout, asphalt material must be moved from station to station as the recycled asphalt product is getting processed in the various portions of the facility. As the movement occurs and as the processing occurs, asphalt and dust from the processing is scattered over the facility and can clog moving parts and pile up around and over the facility structure. In some instances, the facility is shut down for several hours at the end of each day so cleaning can occur to prepare the facility for processing the next day.

We now describe a recycled asphalt facility that grinds, sorts and piles recycled asphalt product in a more vertically-oriented structure that, by its vertical orientation and/or other below-described features, provides a much-improved recycling operation.

### BRIEF DESCRIPTION OF FIGURES

FIG. 1 is a perspective view of an example asphalt recycling plant;

FIG. 2 is another perspective view of an example asphalt recycling plant;

FIG. 3 is a cut-away view of an loader portion and an elevator portion of an example asphalt recycling plant;

FIG. 4 is perspective view of an input portion of an example asphalt recycling plant;

FIG. 5 is a cut-away view of an input conveyor and over-size product return hopper of an example asphalt recycling plant;

FIG. 6 is a perspective view of a sifter assembly of an example asphalt recycling plant; and

FIG. 7 is a schematic representation of an example asphalt recycling plant. ig.

### DESCRIPTION OF A PRESENTLY PREFERRED EMBODIMENT

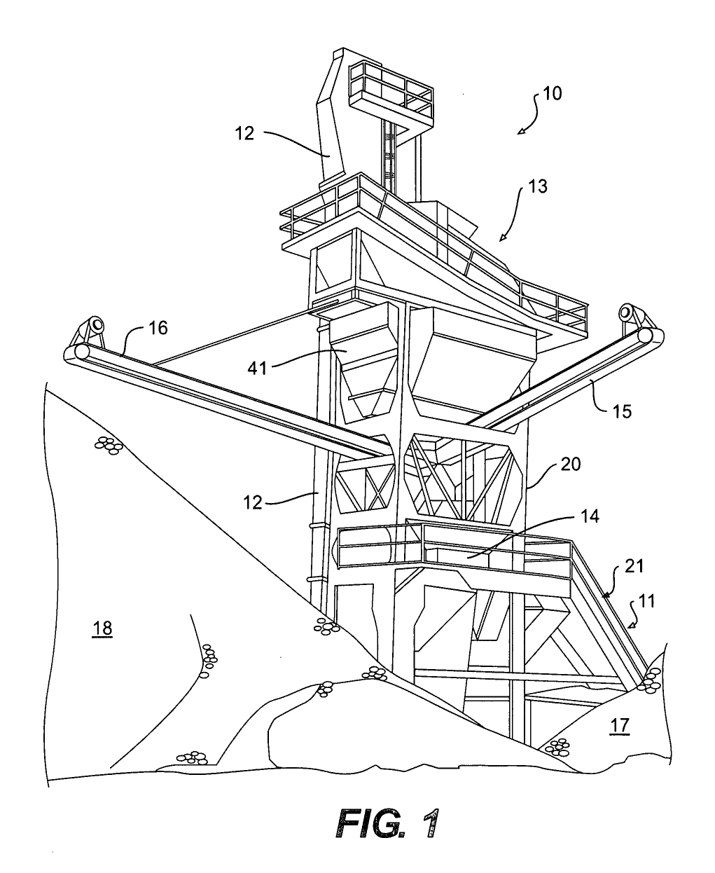

FIG. 1 illustrates an example asphalt processing plant 10 built around a generally vertically-oriented steel frame 20.

Attached to the side of the frame 20 is a loading assembly 11 where previously ground-up road material, asphalt shingles, and other asphalt material is dumped (typically by a front-end loader) onto a first sorting screen 21 comprising of a series of parallel steel bars 22 set a few inches apart. The bars 22 are set apart at a distance such that, once the asphalt product is ground by the road grinder, the material hitting the bars it will nearly all be of sufficiently small size to pass through the first sorting screen 21 into a hopper 23 where it is funneled onto a input conveyor belt described below. The first sorting screen 21 is tilted at an acute angle relative to the ground so larger chunks of asphalt product that are dumped on the first sorting screen 21 cannot pass through the openings between the bars 22 but instead roll back down to the front of the first sorting screen 21 where they can be collected by a front end loader. The angle of the first sorting screen 21 should be set so the larger, heavier chunks of asphalt will roll down the screen 21 and not block the bars 22.

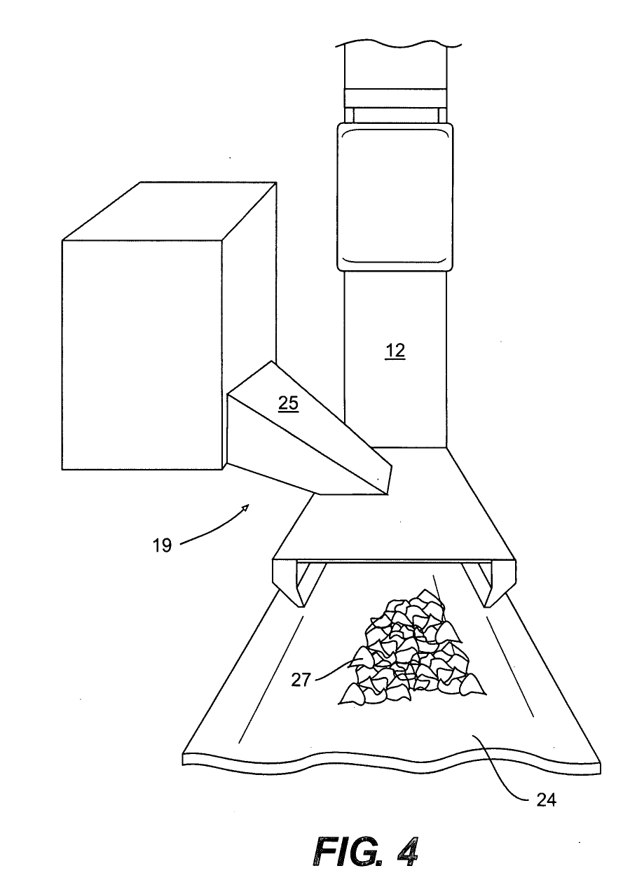

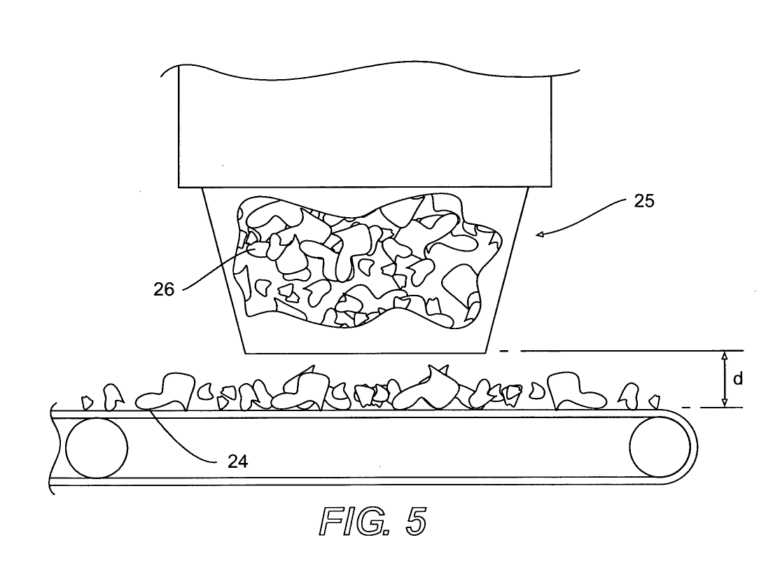

The material passing through the first sorting screen 21 falls into a hopper 23 and is funneled to a conveyor 24 which carries the material to an elevator assembly 12. The conveyor 24 moves the material toward the elevator assembly 12, past an over-size return assembly 19. As will be described in more detail below, the over-size return assembly contains material that was not sufficiently crushed during the process to meet the small size standards required. Because of the vertically-oriented structure, that material falls from structures above and into the over-size return assembly 19, where it is re-placed onto the conveyor 24, with the new material entering from the first sorting screen 21. As shown in FIGS. 4 and 5, the over-size return assembly 19 is arranged with an over-size return hopper 25 where over-size material 26 meets the stream of input material 27 riding along on the conveyor 24. We have discovered that, using this embodiment, the over-size material 26 is actually “pulled” from the over-size return hopper 25 by the input material 27 moving along on the conveyor so the over-size return hopper 25 will not get clogged by the over-size material 26 waiting to be re-introduced into the processing stream. As shown in FIG. 4, the input material 27 passes beneath the over-size return hopper 25—pulling the over-size return material 26 from the hopper, comingling with it, and together moving with the over-size return material 26 into the elevator assembly 12.

The hopper 25 should have a chute-type structure that moves the material into location to comingle with the input material 27. As will be described below, the over-size return material 26 is coming into the hopper 25 from the crusher assembly 14 and can be forced onto the conveyor 24 by the chute-type structure. We have found that a chute of the hopper 25 being at about a 50 degree angle (relative to the horizontal) provides good gravitation movement of the material from the crusher onto the conveyor 24.

As shown in FIG. 5, we have found that a distance “d” between the floor of the plane of the conveyor 23 and the bottom of the over-size material hopper 25 can be about 9 inches when handling most recycled asphalt. That distance forces the material to spread out as a relatively even stream of material heading into the elevator assembly 12 and regulates the flow of input material to the elevator of assembly 12. Of course, different dimensions for “d,” including greater or less than 9 inches can be substituted based on the different design criteria that may be employed for the processing system and the recycled asphalt being processed.

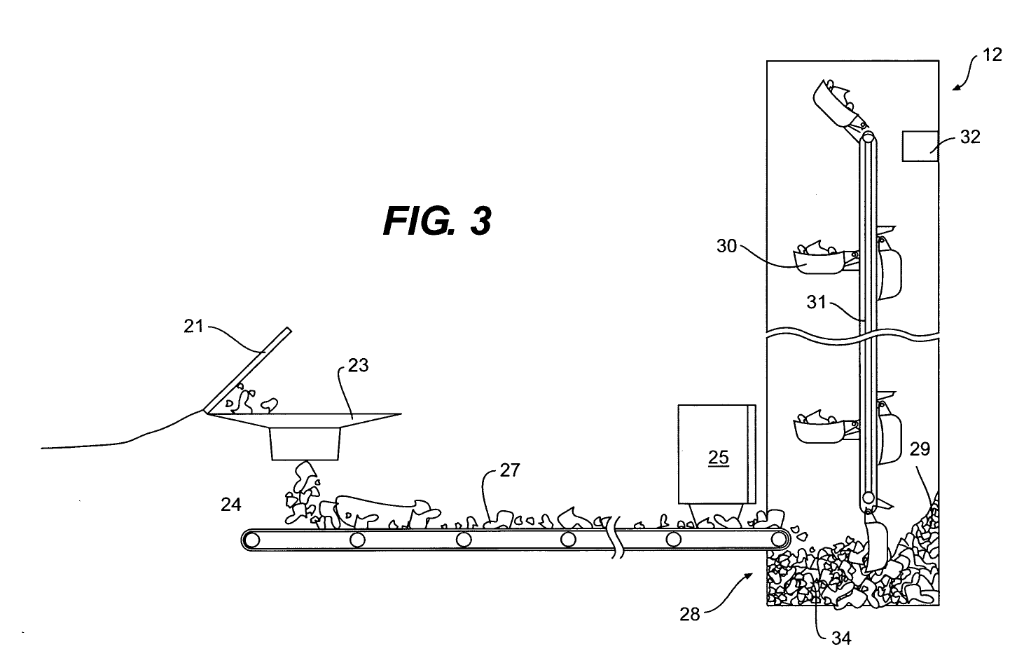

The elevator assembly 12 is responsible for transporting the material to be processed to the top of the processing plant 10. FIG. 3 shows a cut-away view of the elevator assembly 12, and its example position within the plant 10. The material waiting to be processed is delivered, as described earlier, from the input hopper 23, onto the conveyor 24, and past the over-side material hopper 25. The material is dumped into a bottom portion 28 of the elevator assembly where it is picked up by buckets 30 on a moving elevator conveyor 31. We have found that the material builds up at the bottom portion 28 of the elevator without clogging the elevator, and in fact, will build a ledge 29 of material that directs the buckets 30 into the pile 33 where they pick up the material dropped into the bottom portion 28. The buckets 30 travel with the moving conveyor 31 to the top of the elevator assembly 12 and discharge their material into a top chute 32 near the top of the elevator assembly 12. The buckets 30 have holes in the bottoms of their scoops to facilitate removal of the material when the bucket reaches the appropriate discharge location.

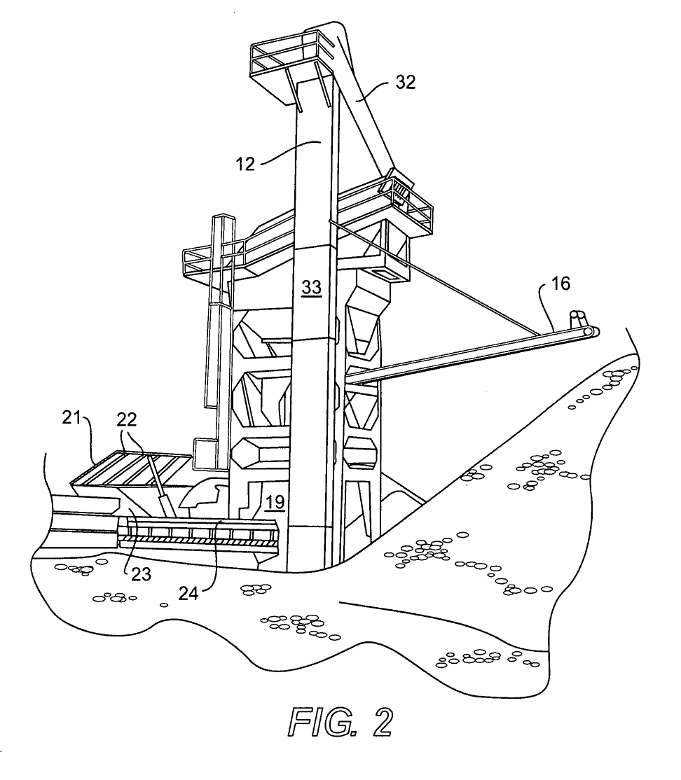

The present embodiment is designed to avoid clogs and messy debris that can force asphalt plants to be frequently shut down for cleaning. As shown in the various figures, including FIGS. 1, 2, 3, and 7, the enclosed elevator assembly 12 can be formed of an elevator chamber 33 that is a contained unit that transports the material to the other processing stations without clogging or throwing dust and debris around the plant. Material 34 dumped into the bottom 28 of the elevator assembly 12 is scooped by the buckets 30 and transported to the top chute 32, without ever being exposed to the outside environment. Debris that falls from the buckets 30 falls to the bottom 28 and is re-scooped by a next-approaching bucket 30. Dust that is normally created by moving asphalt material also stays within the elevator chamber 33 until it is received in the top chute 32 by the buckets 30.

The top chute 32 is angled downwardly at an acute angle appropriate to cause the asphalt material delivered into it from the buckets 30 to move by force of gravity into the sifter assembly 13. One discrete advantage of this vertically-oriented plant 10 is that bottlenecks will not occur in the process because the force of gravity can be used to move the material through the various stations, rather than moving the material by belts that can become clogged. Also, because the material is elevated to a high starting point, there is room enough vertically for the chutes that move the material through the plant 10 to be at relatively sharp angles. For example, the top chute 32 can be 65-70 degrees relative to the horizontal, providing a sharp descent for the material from the bucket 30 discharging the material from the top of the elevator assembly 12 to the sifter assembly 13 below. Like other parts of the plant 10 described, the top chute 32 is a basically sealed system so dust and debris is contained. This is also facilitated by the generally sealed connection of the top chute 32 to the top of the elevator shaft 33 so material that falls from a bucket 30 at the top of the elevator shaft 33 either makes it into the top chute 32 (where it is slid to the sifter assembly 13) or falls back to the bottom 28 of the elevator where it is re-scooped by another bucket 30.

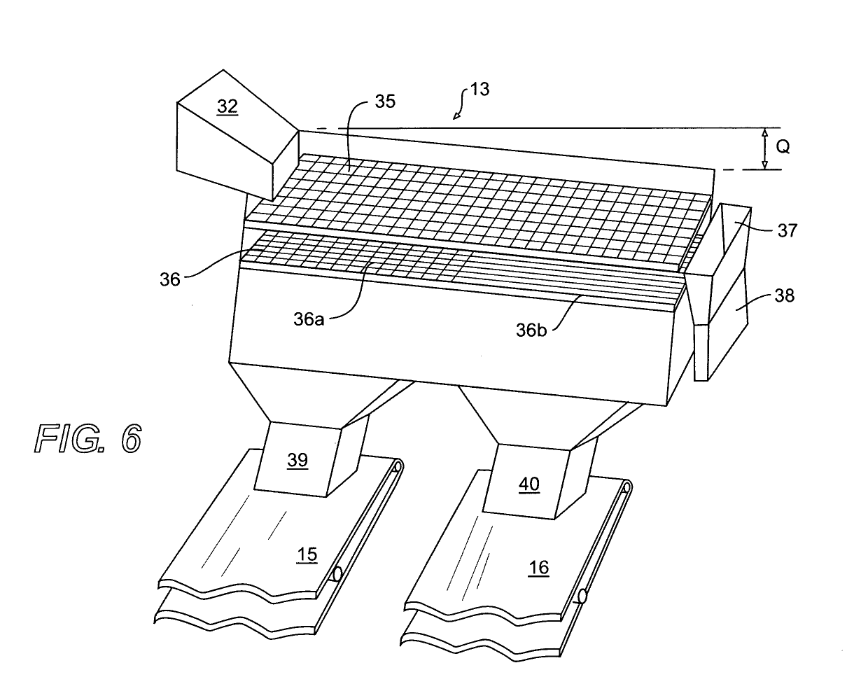

The sifter assembly 13 is designed to sort the material into a number of differently sized asphalt particles. The number and size of the sifters can be modified from the numbers and sized described below, which are but examples of such criteria that can be selected. In one example, two piles of asphalt particle sizes are obtained, a coarse pile having asphalt content of about 5.9 to 6.9, and a fine pile having asphalt content of about 6.9 to 7.2. The concept of asphalt content and its counts is known to the artisan, who will appreciate that the higher the asphalt content, the lower the particle size and the higher the value of the sifted product. FIG. 6 shows an example interior portion of a sifter assembly. Material that arrives from the top chute 32 hits the top of a coarse screen 35 and is constrained by walls (not shown in FIG. 6) to travel either through the coarse screen 35 or down the length of the coarse screen 35 and into a sifter hopper 37. The coarse screen 35 can be standard wire cloth type scrapple deck. The coarse screen 35 is a heavy-duty material that will take the abuse associated with relatively large pieces of colliding asphalt product.

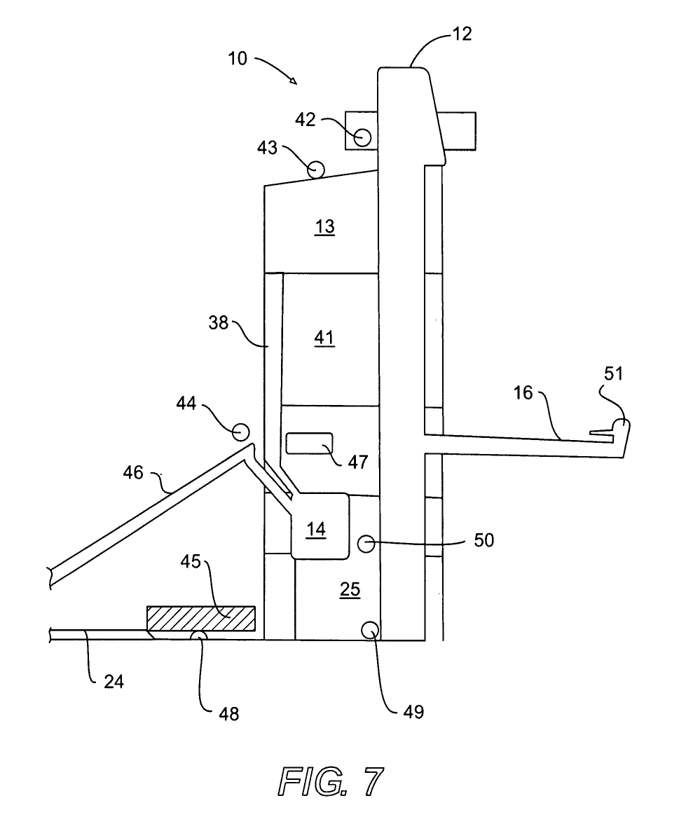

Asphalt product that is too large will not pass through the coarse screen 35, but will instead travel down the length of the coarse screen 35 and fall from its edge into a sifter hopper 37. As shown, the coarse screen 35 (and the fine screen 36 as well) are set at an angle Q relative to the horizontal plane to facilitate the movement of the material down the length of the screens. Also, in operation, the entire sifter assembly 13 is mounted to frame 20 so as to permit vibration movement and is thereby vibrated by a shaker motor 43 (FIG. 7) to assist in moving the material across the faces of the coarse screen 35 and fine screen 36. At the base of the sifter hopper 37 is a sifter chute 38 that directs the larger pieces that fall from the coarse screen 35 into the crusher described in greater detail below. The relatively smaller-sized asphalt material will pass through coarse screen 35 and will land on the plane of the fine screen 36. Material that cannot pass through the fine screen 36, like material that cannot pass through the coarse screen 35 described above, moves along the length of the fine screen 36 until it falls into the sifter hopper 37 and into the sifter chute 38.

At the elevated end of the fine screen 36 is a first screen portion 36a having relatively larger holes of, for example, ¼″×6″. Small grain material that is sized relatively small will pass through these holes in the first screen portion 36a, fall through the small grain chute 39 in the sifter discharge assembly 41 (FIG. 1) and get transported by the small grain conveyor 15 into the small grain pile 17. Material that is larger than the holes in the first screen portion 36a will move down the fine screen 36 to the second screen portion 36b. The second screen portion 36b has holes of, for example, ½″×6″. Medium grain material that is sized appropriately will pass through these holes in the second screen portion 36b, fall through the medium grain chute 40 in the sifter discharge assembly 41 (FIG. 1) and get transported by the medium grain conveyor 16 into the medium grain pile 18.

Again, the sifter assembly 13 and the sifter discharge assembly beneath it are relatively closed assemblies that contain the asphalt material and associated dust during the processing. The only exits from the sifter assembly are the chutes 39 and 40 that lead to the conveyors 15 and 16, and the sifter chute 38 that leads (in a closed system) to the crusher assembly 14. Consequently, from the time the material leaves the input conveyor 24 and enters the oversize return assembly 19, the asphalt material is enclosed (and without any bottlenecks) in the elevator shaft 33, top chute 32, sifter assembly, and sifter discharge assembly 41 until the small grain and medium grain material leaves on conveyors 15 and 16. Even the large grain and over-size material leaves the sifter assembly 13 still within a controlled, closed set of chutes and assemblies leading to the crusher. These closed assemblies and passages are made possible predominantly by gravity feed which utilizes the vertical orientation of the plant 10 and the enclosed elevator which maximizes output and minimizes waste and cleanup.

The sifter chute 38 travels down the frame 20 until it empties into a standard crusher assembly 14. The crusher assembly crushes the materials that enter it and feeds the crushed materials back into the system via the over-size return hopper 25. As can be seen, material that does not make the small grain pile 17 or the medium grain pile 18 via the processes described above is sent to the crusher via closed systems for further reduction and re-insertion into the process via the over-size return assembly 25. Consequently, in general the material remains enclosed and contained within the entire facility until it is sorted out as qualified small grain or medium grain material. All other material stays in the system for as many iterations as necessary until it qualifies as such small grain or medium grain material and is discharged into the corresponding piles. Plus, because there are not belts or the like moving material within the plant 10 after it enters the elevator—but instead the material is moved solely by gravity under the influence of some shaking—the debris and dust does not clog or jam the process. We have continuously operated such a plant 10 for days without substantial scraping or cleaning operation at the rate of 1000 tons per day.

FIG. 7 illustrates the vertical orientation of a plant 10 with some additional equipment. As previously described, the input conveyor 24 delivers the material for comingling with the over-size material from the crusher that had previously failed to make the small-grain or medium-grain standard. The elevator 12 transports the material to the top of the plant 10, where it is discharged into the shifter assembly 13. The sifter assembly 13 sorts the material into small grain and medium grain sizes and delivers them by gravity into the sifter discharge assembly 41 below it. The sifter discharge assembly delivers the small grain and medium grain materials to their corresponding conveyors 15 and 16. The sifter discharge assembly is above the crusher assembly 14, which receives by gravity action any of the material that did not make the small or medium standard, and crushes it further. The crusher is above the over-size return assembly 19, which delivers the crushed product into the new material input stream on the input conveyor 24.

FIG. 7 also shows some optional equipment. As described above, the first sorting screen 21 can have bars that pre-sort the ground up road material so excessively large chunks won't clog the input conveyor 24. In FIG. 7, a grizzly conveyor 46 conveys those excessively large chunks into the crusher 14, which reduces them and puts them into the over-size return assembly with the material returning from the sifter 13. Also, a grizzly shaker 45 can be added above the input conveyor 24 to receive the original ground up road and pre-screen the ground up road by size prior to entrance on the input conveyor 24.

Example additional specifications for the plant of FIG. 7 include:

(1) the elevator 12 can rise 53 feet above the ground;

(2) the top of the sifter assembly 13 can be 45 feet above the ground;

(3) the bottom of the sifter assembly 13 can be 35 feet above the ground;

(4) the small grain and medium grain conveyors 15 and 16 can be 23 feet above the ground;

(5) the top of the crusher assembly 14 can be 15½ feet above the ground;

(6) the elevator motor 42 driving the elevator can be 25 hp;

(7) the shaker motor 43 that shakes the sifter assembly 13 can be 25 hp;

(8) the grizzly conveyor motor 44 that drives the grizzly conveyor 46 can be 25 hp;

(9) the grizzly shaker motor 48 that shakes the grizzly shaker 45 can be 25 hp;

(10) the feeder motor 49 that moves the input conveyor 24 can be 25 hp;

(11) the medium grain conveyor 16 (and the respective small grain conveyor 15) can be can be 25 feet long or longer;

(12) the medium grain conveyor motor 51 (and the respective small grain conveyor motor not shown) can

As can be seen in FIG. 7, the combination of an elevator taking material along a vertically-oriented structure and discharging the material to be processed by, respectively, a sifter assembly located above a crusher assembly located above a return assembly provides dramatic advantages. Two screens in the sifter assembly allow the sifted material to be either sorted and delivered by conveyor into two separate piles of differently-sized asphalt or returned via the crusher and return assembly back into the processing plant, with limited or not external environmental exposure. The vertical orientation keeps the product moving without backlogs, contains the material being processed, and results in virtually no frequent plant downtime. Also, by building the plant vertically, angles of chutes and material moving assemblies can be made at sharp angles to prevent jams and backlogs, and keep the product moving without extra mechanical conveyors.

In another alternative, a grinder can be added that feeds into the input conveyor 24, in a similar location to the shaker 45. The grinder can be used to grind asphalt shingles and pour the ground material into the material 27 coming from the first sorting screen 21.

In another alternative embodiment, the frame 20 can be a recycled batch plant frame.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. An asphalt recycling plant for recycling ground-up road material, comprising:
a frame;
an input screen set an acute angle off of the horizon to receive the ground-up road material and sort out portions of the ground-up road material that have a size corresponding to a size of the input screen;
a conveyor mounted to the frame and receiving the sorted-out portions of the ground-up road material;
a return-material hopper mounted to the frame above the conveyor and outputting return material to the conveyor with the sorted-out portions of the ground-up road material;
an elevator mounted along a vertical length of the frame to receive the return material and the sorted-out portion of the ground-up road material from the conveyor, the elevator having a chamber along its length that is substantially closed to an outside environment during operation;
a top chute supported by the frame near a top of the frame and a top of the elevator to receive the return material and the sorted-out portion of the ground-up road material from the elevator, the top chute being at an acute angle relative to vertical;
a sifter assembly mounted to the frame, so as to permit relative movement therebetween, beneath the top chute and having a top portion near an exit of the top chute to receive the return material and the sorted-out material and to sift the return material and the sorted-out material into fine-grain material, medium-grain material, and return material according to size, the sifter assembly having a top which defines an inner sifter span that is substantially closed to the outside environment during operation;
a vibration motor to facilitate said relative movement between the sifter assembly and the frame;
a crusher assembly mounted to the frame beneath the sifter assembly to receive the return material from the sifter assembly and crush the return material; and
the return-material hopper mounted to the frame beneath the crusher assembly to receive the return material from the crusher.

2. An asphalt recycling plant according to claim 1, wherein:
the frame is a recycled batch plant frame.

3. An asphalt recycling plant according to claim 1, further including:
a hopper beneath the input screen to funnel the sorted-out material onto the conveyor.

4. An asphalt recycling plant according to claim 1, further wherein:
the conveyor further includes an obstacle to smooth the sorted-out material on the conveyor to a maximum height.

5. An asphalt recycling plant according to claim 1, wherein:
the return-material hopper includes a return chute mounted above the conveyor to hold the return material above the sorted-out material so the sorted-out material pulls the return material out of the chute as the sorted-out material passes by the return material on the conveyor.

6. An asphalt recycling plant according to claim 1, wherein:
the elevator, top chute, sifter, crusher and return material hopper form a substantially closed system to the outside environment.

7. An asphalt recycling plant according to claim 1, further including:
a sifter chute mounted between the sifter and the crusher, beneath the sifter and above the crusher.

8. An asphalt recycling plant according to claim 1, further including:
a fine-grain chute to funnel the fine-grain material from the sifter assembly.

9. An asphalt recycling plant according to claim 8, further including:
a fine-grain conveyor receiving the fine-grain material from the fine grain chute and conveying the fine-grain material out of the plant.

10. An asphalt recycling plant according to claim 1, further including:
a fine-grain chute to funnel the fine-grain material from the sifter assembly.
a medium-grain chute to funnel the medium-grain material from the sifter assembly.

11. An asphalt recycling plant according to claim 10, further including:
a fine-grain conveyor receiving the fine-grain material from the fine grain chute and conveying the fine-grain material out of the plant; and
a medium-grain conveyor receiving the medium-grain material from the medium-grain chute and conveying the medium-grain material out of the plant.

12. An asphalt recycling plant according to claim 1, wherein:
the sifter assembly includes a first screen and a second screen, the first screen being mounted to the sifter assembly above the second screen and in a plane substantially parallel to the second screen.

13. An asphalt recycling plant according to claim 12, wherein:
the plane is non-horizontal.

14. An asphalt recycling plant according to claim 1, wherein:
the sifter assembly includes a first screen and a second screen for sorting the return material and the sorted-out material.

15. An asphalt recycling plant according to claim 14, wherein:
the second screen includes a first section for sorting out the fine-grain material and a second section for sorting out the medium-grain material.

16. An asphalt recycling plant according to claim 15, further including:
a fine-grain chute mounted beneath the first section to receive the fine-grain material from the first section;
a medium-grain chute mounted beneath the second section to receive the medium-grain material from the second section;
a fine-grain conveyor receiving the fine-grain material from the fine grain chute and conveying the fine-grain material out of the plant; and
a medium-grain conveyor receiving the medium-grain material from the medium-grain chute and conveying the medium-grain material out of the plant.
